(19) United States
(12) Patent Application Publication
(10) Pub. No.: US 2018/0240171 A1
(43) Pub. Date: Aug. 23, 2018

(54) SYSTEM AND METHODS FOR BIDDING ON MEDICAL DEVICES

(71) Applicant: Jeff Thramann, Longmont, CO (US)

(72) Inventor: Jeff Thramann, Longmont, CO (US)

(21) Appl. No.: 15/753,154

(22) PCT Filed: Aug. 3, 2016
(86) PCT No.: PCT/US2016/045373

§ 371 Date: Feb. 15, 2018

Related U.S. Application Data
(60) Provisional application No. 62/207,070, filed on Aug. 19, 2015.

(51) Int. Cl. G06Q 30/06

(52) U.S. Cl. CPC G06Q 30/0611

(57) ABSTRACT

The technology of the present disclosure includes a method for facilitating the purchase of medical devices. The method includes receiving a medical procedure identifier from a medical provider; determining at least one medical device associated with the medical procedure identifier; transmitting at least one device identifier corresponding to the at least one medical device to the medical provider; receiving a device selection from the medical provider, wherein the device selection identifies at least one selected medical device corresponding to the at least one device identifier; identifying a plurality of vendors based at least in part on the at least one selected medical device; notifying the plurality of vendors of the at least one selected medical device; receiving a plurality of offers from the plurality of vendors, each offer of the plurality of offers comprising device information identifying at least one offered medical device and price information identifying a cost for the at least one offered medical device; selecting a winning vendor from the plurality of vendors based at least in part on the price information of each offer; and instructing the winning vendor to supply the at least one offered medical device to the medical provider, wherein the cost for the at least one offered medical device is based at least in part on the price information.

### RELATED APPLICATIONS

This application claims the benefit of U.S. Provisional Application No. 62/207,070, filed Aug. 19, 2015 the entire disclosure of which is herein incorporated by reference.

### BACKGROUND

Medical providers purchase medical devices through vendors. In some cases, a medical professional employed by the medical provider, such as a surgeon, may have a financial interest in the medical device vendor. For example, the surgeon may have designed a medical implant for the vendor, and may receive a commission from the vendor when the medical implant is sold. Thus, medical professionals may encourage the medical provider to purchase a particular medical device from a particular vendor, at full market price. This arrangement causes the overall cost of a medical procedure to increase and, in certain instances, may be in violation of statutory and regulatory mandate.

### DRAWINGS

Non-limiting and non-exhaustive embodiments of the present invention, including the preferred embodiment, are described with reference to the following figures, wherein like reference numerals refer to like parts throughout the various views unless otherwise specified.

FIG. 1 depicts a block diagram of a medical device bidding system, in accordance with various aspects of the present application.

FIG. 2 is a diagram illustrating a method for facilitating the purchase of medical devices, in accordance with various aspects of the present application.

FIG. 3 depicts a method using the technology of the present application.

FIG. 4 depicts another method using the technology of the present application.

FIG. 5 depicts another method using the technology of the present application.

FIG. 6 depicts a block diagram of a computer system suitable for implementing the present systems and methods.

FIG. 7 is another functional block diagram of a system capable of embodying portions of the technology of the present application.

### DETAILED DESCRIPTION

The technology of the present application will now be described more fully below with reference to the accompanying figures, which form a part hereof and show, by way of illustration, specific exemplary embodiments. These embodiments are disclosed in sufficient detail to enable those skilled in the art to practice the technology of the present application. However, embodiments may be implemented in many different forms and should not be construed as being limited to the embodiments set forth herein. The following detailed description is, therefore, not to be taken in a limiting sense.

The technology of the present application is described with specific reference to medical providers and medical device vendors. However, the technology described herein may be used by buyers and sellers of other types of devices, products, or services. Moreover, the technology of the present application will be described with relation to exemplary embodiments. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein should be considered exemplary.

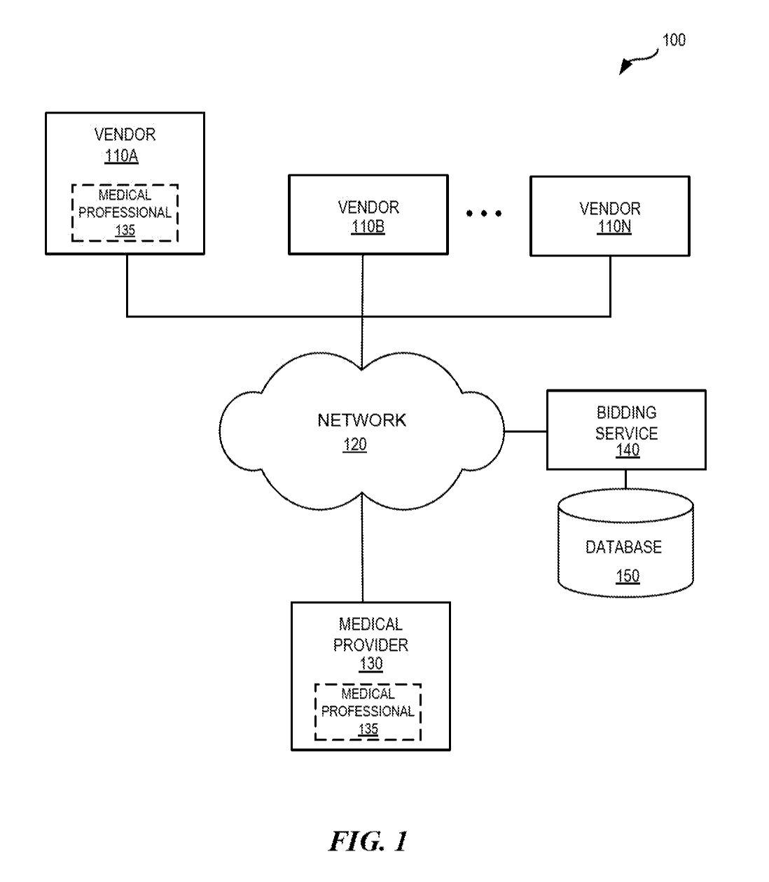

With reference now to FIG. 1, a block diagram of a medical device bidding system 100 is shown, in accordance with various aspects of the present application. The medical device bidding system 100 allows a medical provider 130 and vendors 110A-110N to interactively place requests and offers over a communications network 120. A bidding service 140 automatically records the requests and offers in a database 150, and notifies which vendor 110 submitted a winning offer. The bidding service 140 utilizes a real-time, algorithm-based, system that facilitates the medical providers 130 purchasing of products and services from vendors 110A-110N, with the goal of lowering healthcare costs without adversely affecting patient care.

The medical provider 130, bidding service 140, and vendors 110A-110N may communicate over the network 120 using any device with input and output capabilities that allow communication with a computer network, including a terminal, a personal computer, a mobile telephone, etc. The network 120 may be any type of computer network including a private network such as a corporate intranet or a public network such as the World Wide Web. The bidding service 140 receives information about a requested medical device or devices from the medical provider 130 and stores the information in the database 150. The vendors 110A-110N may then access the request(s) via the bidding service 140 and submit offers to fulfill the request(s) to the bidding service 140. In certain aspects, the bidding service 140 pushes the case request(s) out to the qualified vendors 110A-110N for the specific product that is being bid. The bidding service 140 stores the offers in the database 150 and determines which vendor submitted a winning offer based on one or more criteria.

The medical provider 130 may include a surgical practice, a surgical center, a health care group, a hospital, or other types of healthcare providers. A medical professional 135 may perform various roles for the medical provider 130. These roles may include administrator, surgeon, scheduler, and billing specialist.

The vendors 110A-110N may include medical device manufacturers, resellers, distributors, or other suppliers of medical devices. Generally speaking, the medical device subject to the present application will be considered a commodity and not a custom or specialty device. In some cases, the medical professional 135 working at the medical provider 130 may also have a role at a vendor 110A. For example, a surgeon may have been involved in the vendor's design of a particular medical device for a particular type of surgery. In some cases, the surgeon may receive a financial benefit from the vendor 110A when the particular medical device is sold. In these cases, the surgeon's role at the vendor 110A and at the medical provider 130 may present a conflict when selecting a vendor to supply a medical device for a particular procedure. Thus, the present technology automatically selects a vendor to supply the medical device based on objective criteria, which may allow for purchase of the medical device and compensation to the surgeon without violation of the aforementioned mandates.

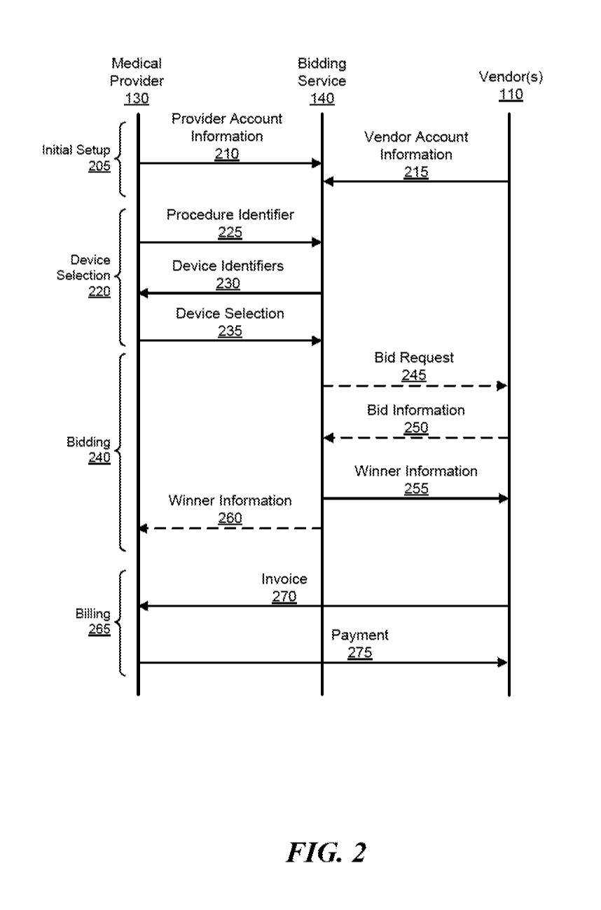

FIG. 2 is a diagram illustrating a method for facilitating the purchase of medical devices, in accordance with various aspects of the present disclosure. In an initial setup phase 205, the bidding service 140 receives provider account information 210 from the medical provider 130. The provider account information 210 may include user information for one or more medical professionals (e.g., name, role, etc.), vendor preferences (e.g., one or more vendors the medical professional prefers to work with, or is authorized to work with), device preferences (e.g., one or more devices or device attributes the medical professional prefers to work with), procedure preferences (e.g., one or more devices or device attributes the medical professional prefers for a particular procedure), and general information regarding the medical provider 130 (e.g., address, phone, etc.). The user information also may indicate whether a medical professional at the medical provider 130 has a financial interest in one or more vendors.

The device preferences and procedure preferences may be used as default values by the bidding service 140 when a medical provider 130 requests devices for a medical procedure. The default values may prepopulate the requirements for a device. However, the default values may be later modified by a medical professional for the particular procedure. Some device preferences may be global preferences and may not change for specific procedures, such as glove size, dominate hand, or certain general surgical supplies. Other device preferences may need to be specified for the particular procedure or patient, such as dressing, skin preparation, or certain specific surgical supplies.

The initial setup phase 205 continues with the bidding service 140 receiving vendor account information 215 from a vendor 110. The vendor account information 215 may include the device types offered by the vendor 110, attributes of the devices, and default or initial pricing information for the devices. The vendor account information 215 allows the bidding service 140 to store a record of what devices the vendor 110 can provide and the list or default price for each device. The vendor account information 215 also provides general details about each device, such as the name and various attributes for each device. Table 1 shows an example of data included in the vendor account information 215 for a vendor 110 that sells pedicle screws:

TABLE 1

| Device | | | | | | |
|---|---|---|---|---|---|---|
| Type | Name | List Price | Sub Type | Diameters | Lengths | Product ID |
| Pedicle | Snowmass | 1500.00 | MIS | 4.5, 5.0, 5.5, 6.0 | 3, 4, 5, 6 | snowmass |
| Screw | | | | | | |
| Pedicle | Sierra | 1800.00 | Open | 4.5, 5.0, 5.5, 6.0 | 2, 3, 4, 5, 6, 7, 10 | sierra |
| Screw | | | | | | |

As shown in Table 1, a Device Type of “Pedicle Screw” may have a variety of specific attributes that describe the product. The specific attributes may vary for different types of devices, but the devices are considered in the industry as a commodity and, generally, fungible.

Table 2 shows an example of additional pricing information that may be included in the vendor account information 215 for a vendor 110 that sells pedicle screws:

TABLE 2

| Medical Provider | Product ID | Negotiated Price | Default Bid Price |
|---|---|---|---|
| Boulder Community | snowmass | 1400.00 | 1300.00 |
| Boulder Community | sierra | 1700.00 | 1400.00 |

As shown in Table 2, the vendor account information 215 may describe the vendor's negotiated price with a particular medical provider. For example, the negotiated price for the “Boulder Community” medical provider is 1400.00 for the “snowmass” product. The vendor account information 215 may also include a default starting bid price, which bid process will be explained further below. For example, the vendor may start their bidding at a price lower than the negotiated price for a particular medical provider. In some examples, if the vendor does not have a negotiated price for a device, then the bidding service may use the list price of the device as the default bid price. The vendor account information 215 may include other fields, such as an auto bid amount. The auto bid amount may allow the bidding service 140 to automatically bid on behalf of the vendor 110 to an amount given in the auto bid amount field. In certain embodiments, the automatic bid may automatically reduce the bid price on indication that the vendor is not winning the bid until the bid minimum or floor is reached.

In some examples, the bidding service 140 maps a set of generally used devices to a particular type of medical procedure, e.g. a commodity product or the like. Alternatively, the vendor account information 215 may specify a set of devices the vendor supplies for a particular type of medical procedure. The mapping may allow a user to locate the necessary devices for a particular procedure more efficiently. Table 3 shows an example of devices that are mapped to an Anterior cervical discectomy and fusion (ACDF) procedure.

TABLE 3

| Device Type | Procedure |
|---|---|
| anterior_cervical_plate | ACDF |
| fusion_system | ACDF |
| interbody_spacer | ACDF |

Alternatively, the vendors 110 may map a set of devices to a particular type of medical procedure. Table 4 shows an example of a Procedure to Product Type mapping provided by a vendor 110. For example, most spine procedures have some type of fixation product type (e.g, pedicle screws, cervical plates), some type of interbody cage product type (ACF, PLIF, ALIF, etc.) and some type of biologic product type.

TABLE 4

| | PROCEDURE | | INTERBODY | |
|---|---|---|---|---|
| REGION | NAME | FIXATION OPTIONS | OPTIONS | BIOLOGICS |
| CERVICAL | ACDF | Anterior Cervical | Cervical Cage | Yes |
| | | Plate ($2,526/surg*) | ($1,384/level) | |
| | | Anchored Cervical | (Anchored | |
| | | Cage ($2,773/level) | Cervical Cage) | |
| CERVICAL | Posterior | PCF Screw Construct | none | Yes |
| | Cervical | ($6,783/surg*) | | |
| | Fusion | Occipital Plate | | |
| | | Construct | | |
| | | ($8,059/surg) | | |
| CERVICAL | Laminoplasty | Laminoplasty Plate | none | Yes |
| | | ($1,200/level) | | |
| CERVICAL | VBR | none | Static VBR | Yes |
| | (Cervical) | | ($2,500/level) | |
| | | | Expandable | |
| | | | VBR | |
| | | | ($7,024/level) | |
| CERVICAL | Cervical | none | Cervical | No |
| | Artificial | | Artificial Disc | |
| | Disc | | ($5,399/level) | |
| THORACOLUMBAR | TLIF | Pedicle Screws | TLIF Cage | Yes |
| | | (Open) ($4,372/surg*) | ($3,838/level) | |
| | | Pedicle Screws (MIS) | | |
| | | ($4,809/surg*) | | |
| | | Spinous Process | | |
| | | Fixation ($5,800/level) | | |
| | | Facet Screws | | |
| | | ($1,600/level) | | |
| THORACOLUMBAR | PLIF | Pedicle Screws | PLIF Cage | Yes |
| | | (Open) ($4,372/surg*) | ($5,757/level) | |
| | | Pedicle Screws (MIS) | | |
| | | ($4,809/surg*) | | |
| | | Spinous Process | | |
| | | Fixation ($5,800/level) | | |
| | | Facet Screws | | |
| | | ($1,600/level) | | |
| THORACOLUMBAR | ALIF | Anterior Lumbar Plate | ALIF Cage | Yes |
| | | ($4,609/level) | ($3,507/level) | |
| | | Anchored Lumbar | (Anchored | |
| | | Cage ($6,807/level) | Lumbar Cage) | |
| | | Pedicle Screws | | |
| | | (Open) ($4,372/surg*) | | |
| | | Pedicle Screws (MIS) | | |
| | | ($4,809/surg*) | | |
| | | Spinous Process | | |
| | | Fixation ($5,800/level) | | |
| | | Facet Screws | | |
| | | ($1,600/level) | | |
| THORACOLUMBAR | LLIF | Lateral Plate | LLIF Cage | Yes |
| | (Lateral) | ($4,069/level) | ($4,711/level) | |
| | | Anchored Lateral | (Anchored | |
| | | Cage ($6,807/level) | Lateral Cage) | |
| | | Pedicle Screws | | |
| | | (Open) ($4,372/surg*) | | |
| | | Pedicle Screws (MIS) | | |
| | | ($4,809/surg*) | | |
| | | Spinous Process | | |
| | | Fixation ($5,800/level) | | |
| | | Facet Screws | | |
| | | ($1,600/level) | | |
| THORACOLUMBAR | Posterior | Pedicle Screws | none | Yes |
| | Lumbar | (Open) ($4,372/surg*) | | |
| | Fusion | Pedicle Screws (MIS) | | |
| | (no IBF) | ($4,809/surg*) | | |
| | | Spinous Process | | |
| | | Fixation ($5,800/level) | | |
| | | Facet Screws | | |
| | | ($1,600/level) | | |
| THORACOLUMBAR | VBR | None | Static VBR | Yes |
| | (Lumbar) | | ($2,500/level) | |
| | | | Expandable | |
| | | | VBR | |
| | | | ($7,024/level) | |
| THORACOLUMBAR | Vertebroplasty | Pedicle Screws | Vertebroplasty | Yes (w/ |
| | | (Open) ($4,372/surg*) | ($926/level) | Fixation) |
| | | Pedicle Screws (MIS) | Kyphoplasty | |
| | | ($4,809/surg*) | ($3,000/level) | |
| | | Spinous Process | | |
| | | Fixation ($5,800/level) | | |
| | | Facet Screws | | |
| | | ($1,600/level) | | |
| THORACOLUMBAR | Lumbar | none | Anterior | No |
| | Artificial | | Lumbar | |
| | Disc | | Artificial Disc | |
| | | | Lateral Artificial | |
| | | | Disc | |
| SACROILIAC | SI Fusion | SI Fusion | none | Yes |
| | | Dowels/Screws | | |
| | | ($3,000/surg?) | | |

As an example, if a medical provider 130 selects a TLIF procedure, the medical provider 130 would then select a type of fixation product type based on the set of devices mapped to the procedure (e.g., open pedicle screws, MIS pedicle screws, spinous process fixation or facet screws). The medical provider 130 also may select an interbody type (e.g., a TLIF cage), and a type of biologic. As another example, the medical provider 130 may design a 3-level TLIF procedure where two levels get open pedicle screws and one level gets spinous process fixation. Thus, the medical provider 130 may select multiple device types for a given procedure.

The vendor account information 215 provided to the bidding service 140 may be searchable by the bidding service 140 or by the medical provider 130. This may allow the bidding service 140 to locate devices with attributes matching the preferences of the medical provider 130.

In a device selection phase 220, the medical provider 130 determines a particular medical procedure being performed, and sends a procedure identifier 225 to the bidding service 140. The procedure identifier 225 identifies the particular procedure being performed, and optionally includes specific vendor preferences, device preferences, attribute preferences, and/or procedure preferences for the particular medical procedure. If specific preferences are not included with the procedure identifier 225, then the bidding service 140 may use the medical provider's default preferences included in the provider account information 210, if available.

Once the procedure identifier 225 is sent to the bidding service 140, the bidding service 140 returns a set of device identifiers 230 to the medical provider 130. The device identifiers 230 may be associated with a set of devices meeting the medical provider's preferences included in the procedure identifier 225 and/or the provider account information 210. Alternatively, the device identifiers 230 may be associated with a set of devices commonly used for the particular medical procedure. The commonly used set of devices may be sorted according to the medical provider's preferences included in the procedure identifier 225 and/or the provider account information 210. For each device, the medical provider 130 may select which devices will be used for the medical procedure. The medical provider 130 may then further refine the attributes for the devices. The vendor preferences, device preferences, and/or attribute preferences may be used to narrow down the options presented to the medical provider 130. If the medical provider's preferences filter out all possible vendors (or all vendors not affiliated with the medical professional 135 of the medical provider 130), then the bidding service 140 may provide a notification that the medical provider's preferences should be less specific. Once the medical provider 130 identifies the devices and attributes for the medical procedure, the medical provider 130 sends a device selection 235 to the bidding service 140.

As an example, the medical provider 130 may be performing a Transforaminal Lumbar Interbody Fusion (TLIF) procedure. The medical provider 130 transmits a TLIF procedure identifier 225 to the bidding service 140, which then returns device identifiers 230 associated with a set of devices for the TLIF procedure. As an example, the set of devices may include pedicle screws. The vendor and/or type of pedicle screws included in the set of devices may be defined by the medical provider's preferences included in the provider account information 210 and/or the procedure identifier 225. Alternatively, the device identifiers 230 may include all pedicle screws for a TLIF procedure. The medical provider 130 may then select specific attributes for the pedicle screws, such as OPEN or MIS. The bidding service 140 then receives the medical provider's selection 235 of the particular type of pedicle screw desired for the TLIF procedure.

In some examples, the medical provider 130 may add additional devices not associated with the particular medical procedure by default. For example, the medical provider 130 may search the bidding service's database 150 for a particular device and add the particular device to the set of devices associated with the procedure identifier 225. In addition, the medical provider 130 may specify backup devices for a medical procedure. The bidding service 140 may request vendors supply the backup devices if the preferred or default devices are unavailable. The medical provider's preference for backup devices may be included in the provider account information 210.

After the device selection phase 220, the bidding service 140 selects one or more vendors to supply the selected device(s) in a bidding phase 240. In order to obtain bids from preferred vendors 110, the bidding service 140 may first narrow down the possible vendors based on the medical provider's vendor preferences included in the provider account information and/or procedure identifier 225. After one or more preferred vendor(s) are identified, the bidding service 140 may further narrow down the preferred vendor(s) to one or more qualified vendor(s) 110 that carry the device(s) corresponding to the device selection 235 (i.e., device(s) for a particular medical procedure having particular attributes selected by the medical provider 130). The bidding service 140 may accomplish this by comparing the device attributes selected by the medical provider 130 to the devices and attributes provided by the preferred vendor(s) in the vendor account information 215. For example, if the selected device is a pedicle screw with an MIS attribute type, then the bidding service 140 may identify qualified vendors that carry MIS pedicle screws for inclusion in the bidding phase 240.

In some examples, the bidding service 140 selects a winning vendor without input from the qualified vendor(s) during the bidding phase 240. The bidding service 140 may select the winning vendor based on each qualified vendor's default bid price for the selected device(s). For example, in an emergency procedure, the bidding may be limited to list or default prices in view of timing for scheduling to performance of the procedure. The default bid price was previously provided to the bidding service 140 in the vendor account information 215 during the initial setup phase 205. The bidding service 140 may select a winning vendor based on which qualified vendor provides the selected device(s) at the lowest price. Alternatively, the bidding service 140 may select a winning vendor based on a combination of criteria, such as price, quality, medical provider preferences, additional attributes of the device, etc.

In some examples, each medical device requested through the bidding service 140 includes one or more attributes, allowing the medical provider 130 to establish minimum acceptable criteria (e.g., product requirements) for one or more of the attributes. In addition, the vendor(s) 110 may define their own criteria (e.g., product specifications) for one or more of the attributes. These attributes may provide a common and objective set of criteria for selecting a vendor 110 for the medical provider 130.

In some examples, the bidding service 140 may select the winning vendor based on which vendor provided an offer having greatest overall value, where the overall value considers additional criteria other than price. A number of factors may affect the overall value beyond price. For example, the medical provider 130 may value implants that are pre-packaged sterile at $25 per implant more than an equivalent non-sterile implant (where $25 may be the cost the medical provider 130 has determined offsets their cost of sterilizing and processing a non-sterile implant). Preferring a sterilized product may not be a fixed attribute, but the medical provider 130 may be willing to pay an extra $25 for a device having that attribute. Additional examples of an attribute that the medical provider 130 may value, but not require, include having a vendor's representative/technician available for the medical procedure, having particular instruments available that make a procedure easier to perform, or having the vendor agree to help the medical provider 130 track key metrics when using the medical device. Each attribute of the medical device may be assigned a dollar value by the medical provider 130 or by the bidding service 140. Thus, the bidding service 140 may include the value of the attributes when determining which vendor's offer has the greatest overall value.

The overall value is what is used by the bidding service 140 to determine the winning vendor, but the bid price is what the winning vendor 110 will use for the invoice to the medical provider 130. For example, if Vendors A and B both have a default bid price of $500 for otherwise identical implants, but Vendor A's implant is sterile-packed (with an attribute value of $25) and Vendor B's implant is not sterile packed, then Vendor A would win the bid with an overall value of $475. However, Vendor A would actually sell their implant to the medical provider 130 at $500.

Once the winning vendor 110 is selected, the bidding service 140 sends winner information 255 to the vendor 110. The winner information 255 notifies the vendor 110 to supply the selected device(s) to the medical provider 130 at a price corresponding to the default bid price included in the vendor account information 215. The bidding service 140 also may send winner information 260 to the medical provider 130. The winner information 260 notifies the medical provider 130 which vendor 110 will be supplying the selected device(s) and the cost of the selected device(s). Information also may be provided to the bidding vendor that did not win the bid process. The information to the non-winning vendors may include price differentials, ancillary value information or overall product portfolio information.

In other examples, the bidding service 140 sends a bid request 245 to the vendor(s) 110. The bid request 245 includes information about the device(s) and attribute(s) selected by the medical provider 130. The bid request 245 allows the qualified vendor(s) 110 to provide different bid prices within a predetermined time period. The bidding service 140 may send the bid request 245 to the qualified vendor(s) 110 that meet the medical provider's vendor preferences. Alternatively, the bidding service 140 may send the bid request 245 to all vendors 110, even if they are not preferred or do not carry a device having the selected attributes. This may allow all vendors to see gaps that exist between their device(s) and the device(s) selected by the medical provider 130.

The vendor(s) 110 may send bid information 250 to the bidding service 140 before the predetermined time period expires. The bid information 250 includes an offer to provide the selected device(s) at an offered price or with other ancillaries as mentioned herein. During the predetermined time period, the vendor(s) may receive information about other offers from other vendors. In this way, each vendor may determine if they are currently winning or losing the bid and by how much. Each vendor may have the option to send additional bid information 250 during the predetermined time period in order to adjust their offers. The predetermined time period is established by the medical provider 130, based on when the requested device(s) are needed (e.g., when the upcoming procedure is scheduled to occur).

At the end of the predetermined time period, the bidding service 140 may select a winning vendor based on which vendor's bid information 250 included an offer with the lowest price. Alternatively, the bidding service 140 may select a winning vendor based on a combination of criteria, such as price, quality, medical provider preferences, additional attributes of the device, etc.

As described above, in some examples, each medical device requested through the bidding service 140 includes one or more attributes, allowing the medical provider 130 to establish minimum acceptable criteria (e.g., product requirements) for one or more of the attributes. In addition, the vendor(s) 110 may define their own criteria (e.g., product specifications) for one or more of the attributes. These attributes may provide a common and objective set of criteria for matching the medical provider 130 with a vendor 110.

Once the winning vendor 110 is selected, the bidding service 140 sends winner information 255 to the vendor 110. The winner information 255 notifies the vendor 110 to supply the selected device(s) to the medical provider 130 at the offered price in the bid information 250. Losing vendors also may be notified of the winning offer price and/or overall value of the winning offer. This may provide the losing vendors with information that they can use to modify future offers to be more competitive.

The bidding service 140 also may send winner information 260 to the medical provider 130. The winner information 260 notifies the medical provider 130 which vendor 110 will be supplying the selected device(s) and the offered price of the selected device(s).

In other examples, the bidding service 140 may use an auto bid system. Each vendor may provide minimum auto bid value in the vendor account information 215. The bidding service 140 may then automatically place bids on each qualified vendor's behalf until the minimum auto bid value is reached. At that point, each vendor may have an option to send bid information 250 with a lower offered price for the selected device(s) or provide other value enhancements. The bidding service 140 may then select a winning vendor as described above.

After the device selection phase 220 and bidding phase 240, the medical provider 130 and winning vendor 110 complete the billing phase 265. The winning vendor 110 sends an invoice 270 to the medical provider 130. The cost for the device(s) on the invoice 265 correspond to the price of the winning offer or the lowest default bid price. In some examples, the medical provider 130 and/or vendor(s) 110 may link their invoicing systems to the bidding service 140. Linking invoicing systems may assure that the invoices generated for the selected device(s) match the offered price of the winning vendor 110. After receiving the invoice 270, the medical provider 130 may send a payment 275 to the winning vendor 110.

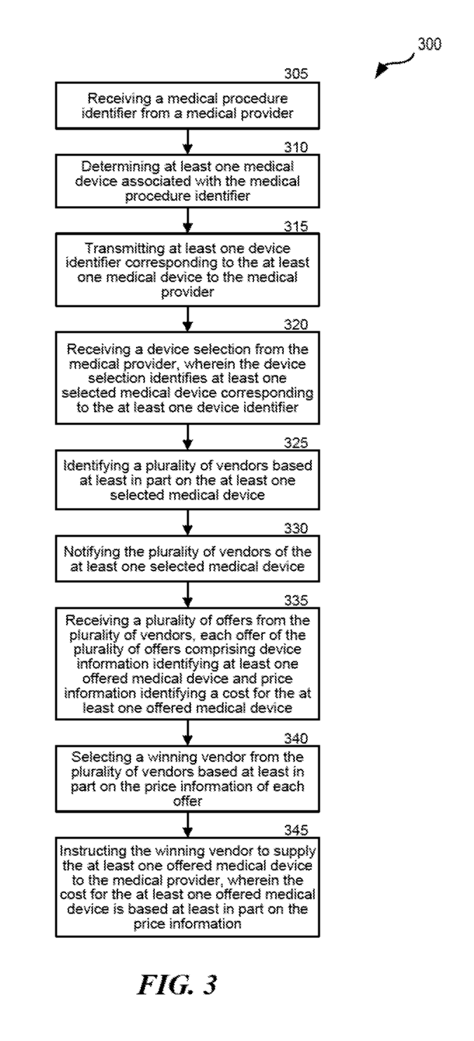

With reference now to FIG. 3, a method 300 using the technology of the present application is provided. In some examples, the method 300 may be implemented by the bidding service 140 described with reference to FIGS. 1 and 2. A step 305 includes receiving a medical procedure identifier from a medical provider. A step 310 includes determining at least one medical device associated with the medical procedure identifier. A step 315 includes transmitting at least one device identifier corresponding to the at least one medical device to the medical provider. In some examples, the at least one device identifier indicates at least one attribute for the at least one medical device. The at least one attribute may include one or more of a size of the at least one medical device, a category of the at least one medical device, an accessory for the at least one medical device, packaging for the at least one medical device, or medical procedure information associated with the at least one medical device. A step 320 includes receiving a device selection from the medical provider. In some examples, the device selection indicates at least one selected attribute for the at least one selected medical device. The device selection identifies at least one selected medical device corresponding to the at least one device identifier. A step 325 includes identifying a plurality of vendors based at least in part on the at least one selected medical device. A step 330 includes notifying the plurality of vendors of the at least one selected medical device. A step 335 includes receiving a plurality of offers from the plurality of vendors. The step of receiving the plurality of offers from the plurality of vendors may include alerting one or more vendors that a bid is not currently a winning bid and receiving a subsequent bid thereto. Each offer of the plurality of offers includes device information identifying at least one offered medical device and price information identifying a cost for the at least one offered medical device. A step 340 includes selecting a winning vendor from the plurality of vendors based at least in part on the price information of each offer. In some examples, selecting the winning vendor is further based at least in part on an overall value of each offer. The overall value includes an effective value of at least one attribute of the offered medical device. A step 345 includes instructing the winning vendor to supply the at least one offered medical device to the medical provider. The cost for the at least one offered medical device is based at least in part on the price information.

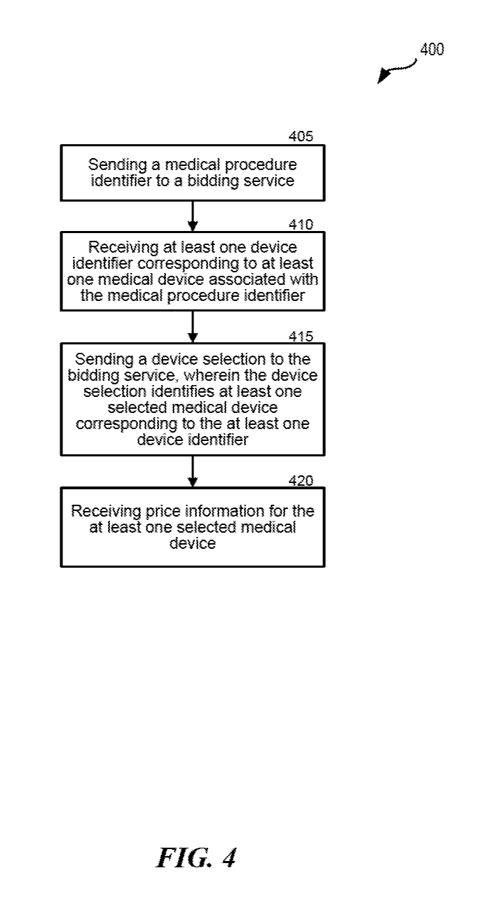

With reference now to FIG. 4, another method 400 using the technology of the present application is provided. In some examples, the method 400 may be implemented by the medical provider 130 described with reference to FIGS. 1 and 2. A step 405 includes sending a medical procedure identifier to a bidding service. A step 410 includes receiving at least one device identifier corresponding to at least one medical device associated with the medical procedure identifier. In some examples, the at least one device identifier indicates at least one attribute for the at least one medical device. The at least one attribute may include one or more of a size of the at least one medical device, a category of the at least one medical device, an accessory for the at least one medical device, packaging for the at least one medical device, or medical procedure information associated with the at least one medical device. A step 415 includes sending a device selection to the bidding service. The device selection identifies at least one selected medical device corresponding to the at least one device identifier. In some examples, the device selection indicates at least one selected attribute for the at least one selected medical device. A step 420 includes receiving price information for the at least one selected medical device.

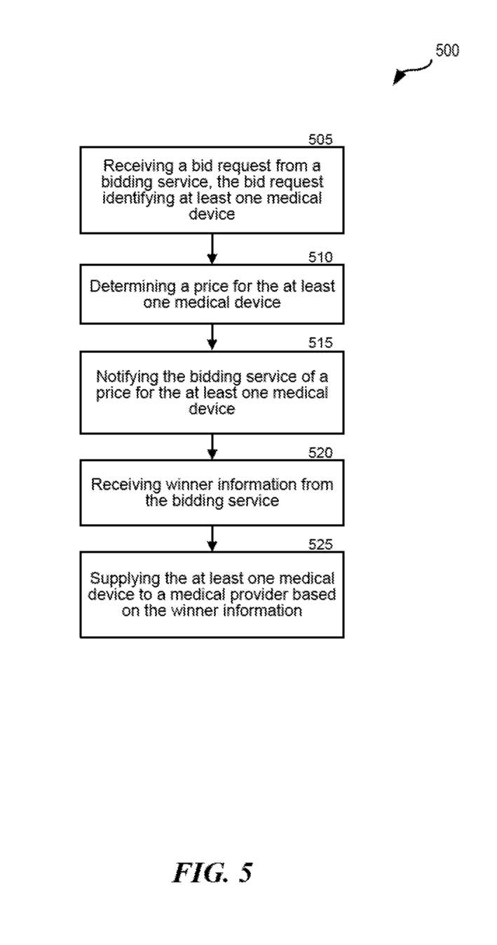

With reference now to FIG. 5, another method 500 using the technology of the present application is provided. In some examples, the method 500 may be implemented by one or more of the vendors 110 described with reference to FIGS. 1 and 2. A step 505 includes receiving a bid request from a bidding service; the bid request identifying at least one medical device. A step 510 includes determining a price for the at least one medical device. A step 515 includes notifying the bidding service of a price for the at least one medical device. A step 520 includes receiving winner information from the bidding service. A step 525 includes supplying the at least one medical device to a medical provider based on the winner information.

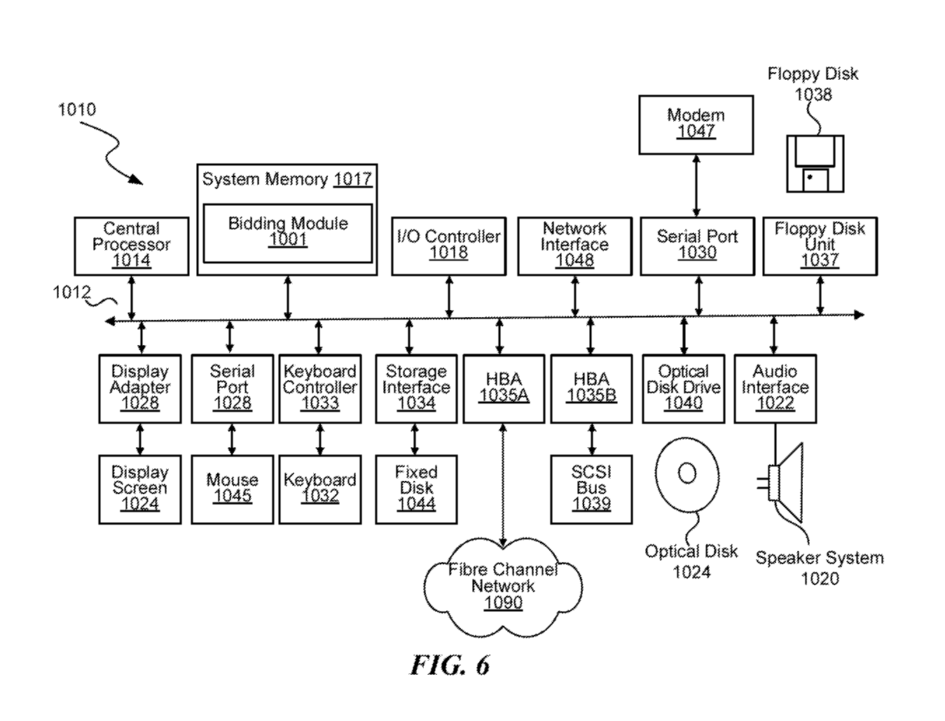

FIG. 6 depicts a block diagram of a computer system 1010 suitable for implementing the present systems and methods. For example, the computer system 1010 may implement the systems and methods of the medical provider 130, the bidding service 140, and/or the vendors 110. Computer system 1010 includes a bus 1012 which interconnects major subsystems of computer system 1010, such as a central processor 1014, a system memory 1017 (typically RAM, but which may also include ROM, flash RAM, or the like), an input/output controller 1018, an external audio device, such as a speaker system 1020 via an audio output interface 1022, an external device, such as a display screen 1024 via display adapter 1026, serial ports 1028 and 1030, a keyboard 1032 (interfaced with a keyboard controller 1033), multiple USB devices 1092 (interfaced with a USB controller 1090), a storage interface 1034, a floppy disk drive 1037 operative to receive a floppy disk 1038, a host bus adapter (HBA) interface card 1035A operative to connect with a Fibre Channel network 1090, a host bus adapter (HBA) interface card 1035B operative to connect to a SCSI bus 1039, and an optical disk drive 1040 operative to receive an optical disk 1042. Also included are a mouse 1046 (or other point-and-click device, coupled to bus 1012 via serial port 1028), a modem 1047 (coupled to bus 1012 via serial port 1030), and a network interface 1048 (coupled directly to bus 1012).

Bus 1012 allows data communication between central processor 1014 and system memory 1017, which may include read-only memory (ROM) or flash memory (neither shown), and random access memory (RAM) (not shown), as previously noted. The RAM is generally the main memory into which the operating system and application programs are loaded. The ROM or flash memory can contain, among other codes, the Basic Input-Output system (BIOS) which controls basic hardware operation such as the interaction with peripheral components or devices. For example, a bidding module 1001 to implement the present systems and methods may be stored within the system memory 1017.

Applications resident with computer system 1010 are generally stored on and accessed via a computer readable medium, such as a hard disk drive (e.g., fixed disk 1044), an optical drive (e.g., optical drive 1040), a floppy disk unit 1037, or other storage medium. Additionally, applications can be in the form of electronic signals modulated in accordance with the application and data communication technology when accessed via network modem 1047 or interface 1048.

Storage interface 1034, as with the other storage interfaces of computer system 1010, can connect to a standard computer readable medium for storage and/or retrieval of information, such as a fixed disk drive 1044. Fixed disk drive 1044 may be a part of computer system 1010 or may be separate and accessed through other interface systems. Modem 1047 may provide a direct connection to a remote server via a telephone link or to the Internet via an Internet service provider (ISP). Network interface 1048 may provide a direct connection to a remote server via a direct network link to the Internet via a POP (point of presence). Network interface 1048 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras and so on). Conversely, all of the devices shown in FIG. 6 need not be present to practice the present systems and methods. For example, the computer system 1010 may be a mobile device, such as a cellular telephone. The devices and subsystems can be interconnected in different ways from that shown in FIG. 6. The operation of a computer system, such as that shown in FIG. 6, is readily known in the art and is not discussed in detail in this application. Code to implement the present disclosure can be stored in computer-readable medium such as one or more of system memory 1017, fixed disk 1044, optical disk 1042, or floppy disk 1038. The operating system provided on computer system 1010 may be MS-WINDOWS®, UNIX®, Linux®, iOS, Android, or another known operating system.

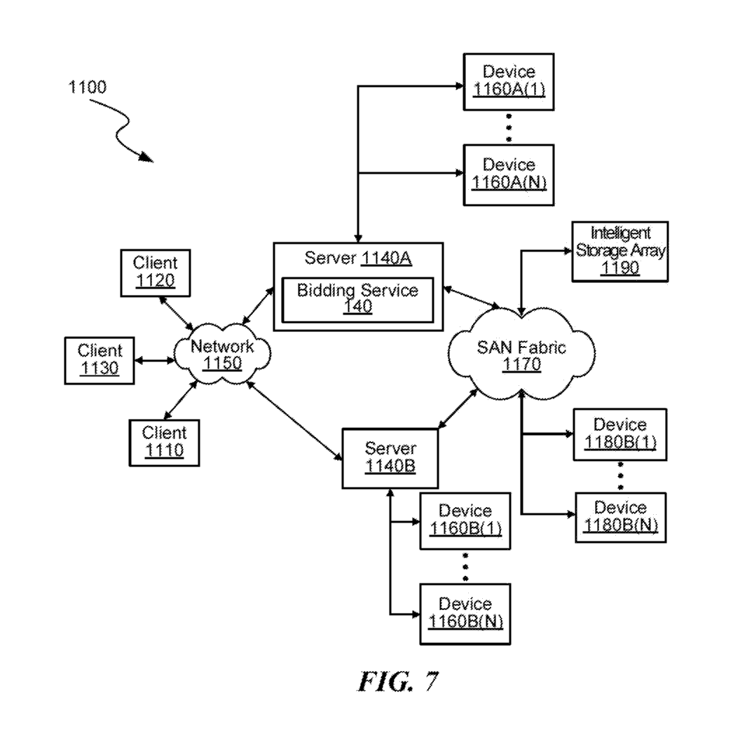

FIG. 7 is a block diagram depicting a network architecture 1100 in which client systems 1110, 1120 and 1130, as well as storage servers 1140A and 1140B (any of which can be implemented using computer system 1010), are coupled to a network 1150. In one embodiment, the bidding service 140 may be located within a server 1140A to implement the present systems and methods. The medical provider 130 and vendors 110 may communicate with the bidding service 140 using one or more clients or one or more servers. The server 1140A is further depicted as having storage devices 1160A(1)-(N) directly attached, and storage server 1140B is depicted with storage devices 1160B(1)-(N) directly attached. SAN fabric 1170 supports access to storage devices 1180(1)-(N) by servers 1140A and 1140B, and so by client systems 1110, 1120 and 1130 via network 1150. Intelligent storage array 1190 is also shown as an example of a specific storage device accessible via SAN fabric 1170.

With reference to computer system 1010, modem 1047, network interface 1048, or some other method can be used to provide connectivity from each of client computer systems 1110, 1120, and 1130 to network 1150. Client systems 1110, 1120, and 1130 are able to access information on server 1140A or 1140B using, for example, a web browser or other client software (not shown). Such a client allows client systems 1110, 1120, and 1130 to access data hosted by storage server 1140A or 1140B or one of storage devices 1160A(1)-(N), 1160B(1)-(N), 1180B(1)-(N) or intelligent storage array 1190. FIG. 7 depicts the use of a network, such as the Internet, for exchanging data, but the present systems and methods are not limited to the Internet or any particular network-based environment.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature since many other architectures can be implemented to achieve the same functionality.

Although the technology has been described in language that is specific to certain structures and materials, it is to be understood that the invention defined in the appended claims is not necessarily limited to the specific structures and materials described. Rather, the specific aspects are described as forms of implementing the claimed invention. Because many embodiments of the invention can be practiced without departing from the spirit and scope of the invention, the invention resides in the claims hereinafter appended. Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques. Moreover, all ranges disclosed herein are to be understood to encompass and provide support for claims that recite any and all subranges or any and all individual values subsumed therein. For example, a stated range of 1 to 10 should be considered to include and provide support for claims that recite any and all subranges or individual values that are between and/or inclusive of the minimum value of 1 and the maximum value of 10; that is, all subranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

1. A method for facilitating the purchase of medical devices, the method comprising:
receiving a medical procedure identifier from a medical provider;
determining at least one medical device associated with the medical procedure identifier;
transmitting at least one device identifier corresponding to the at least one medical device to the medical provider;
receiving a device selection from the medical provider, wherein the device selection identifies at least one selected medical device corresponding to the at least one device identifier;
identifying a plurality of vendors based at least in part on the at least one selected medical device;
notifying the plurality of vendors of the at least one selected medical device;
receiving a plurality of offers from the plurality of vendors, each offer of the plurality of offers comprising device information identifying at least one offered medical device and price information identifying a cost for the at least one offered medical device;
selecting a winning vendor from the plurality of vendors based at least in part on the price information of each offer, wherein the medical provider is blinded from the selecting step; and
instructing the winning vendor to supply the at least one offered medical device to the medical provider, wherein the cost for the at least one offered medical device is based at least in part on the price information.

2. The method of claim 1, wherein selecting the winning vendor is based at least in part on an overall value of each offer, the overall value including an effective value of at least one attribute of the offered medical device.

3. The method of claim 1, wherein the at least one device identifier indicates at least one attribute for the at least one medical device.

4. The method of claim 3, wherein the at least one attribute comprises one or more of a size of the at least one medical device, a category of the at least one medical device, an accessory for the at least one medical device, packaging for the at least one medical device, or medical procedure information associated with the at least one medical device.

5. The method of claim 3, wherein the device selection indicates at least one selected attribute for the at least one selected medical device.

6. A method for facilitating the purchase of medical devices, the method comprising:
sending a medical procedure identifier to a bidding service;
receiving at least one device identifier corresponding to at least one medical device associated with the medical procedure identifier;
sending a device selection to the bidding service, wherein the device selection identifies at least one selected medical device corresponding to the at least one device identifier; and
receiving price information for the at least one selected medical device.

7. The method of claim 6, wherein the at least one device identifier indicates at least one attribute for the at least one medical device.

8. The method of claim 7, wherein the at least one attribute comprises one or more of a size of the at least one medical device, a category of the at least one medical device, an accessory for the at least one medical device, packaging for the at least one medical device, or medical procedure information associated with the at least one medical device.

9. The method of claim 7, wherein the device selection indicates at least one selected attribute for the at least one selected medical device.

10. The method of claim 1, wherein at least one of the plurality of vendors is a vendor of which the medical provider is an owner.

11. The method of claim 10, wherein the step of selecting the winning vendor comprises selecting the vendor of which the medical provider is an owner.

12. The method of claim 11, wherein the selecting step wherein the medical provider cannot influence the selection of the winning vendor.

13. A method for facilitating the purchase of medical devices, the method comprising:
receiving a bid request from a bidding service, the bid request identifying at least one medical device;
determining a price for the at least one medical device;
notifying the bidding service of a price for the at least one medical device;
receiving winner information from the bidding service, wherein a medical provider using the at least one medical device in a medical procedure cannot influence the received winning information and must use the at least one medical device from the winning information; and
supplying the at least one medical device to a medical provider based on the winner information.
